(19) United States
(12) Patent Application Publication
(10) Pub. No.: US 2025/0103825 A1
(43) Pub. Date: Mar. 27, 2025

(54) METHOD FOR GENERATING DIALOGUE, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Xinchao Xu, Beijing (CN); Wenquan Wu, Beijing (CN)

(73) Assignee: BEIJING BAIDU NETCOM SCIENCE TECHNOLOGY CO., LTD., Beijing (CN)

(21) Appl. No.: 18/974,450

(22) Filed: Dec. 9, 2024

(30) Foreign Application Priority Data
Sep. 10, 2024 (CN) 2024112699877

(51) Int. Cl. G06F 40/35

(52) U.S. Cl. CPC G06F 40/35

(57) ABSTRACT

A method for generating a dialogue includes acquiring a current first question statement and historical dialogue information associated with the first question statement; acquiring, from a knowledge base, a first knowledge item associated with the first question statement and a second knowledge item having a question-answer relationship with the first knowledge item; obtaining a first reply statement output by a generative model by inputting the first question statement, the first knowledge item, and the historical dialogue information into the generative model; evaluating the first reply statement based on the first question statement, the first knowledge item, and the second knowledge item; and outputting the first reply statement in response to the first reply statement passing evaluation.

### CROSS REFERENCE TO RELATED APPLICATION

This application is based on and claims priority to Chinese patent application No. 2024112699877, filed on Sep. 10, 2024, the entire content of which is hereby introduced into this application as a reference.

### TECHNICAL FIELD

The present disclosure relates to the technical field of artificial intelligence, such as natural language processing, large model, and deep learning, and in particular to a method for generating a dialogue, and an electronic device, and a storage medium.

### BACKGROUND

With rapid development of artificial intelligence technology, a dialogue system has been widely used in various fields such as intelligent customer service, smart homes, and online education. The current dialogue generation solution has low performance when facing complex and changing language environments and knowledge requirements.

### SUMMARY

According to a first aspect of the present disclosure, a method for generating a dialogue is provided. The method includes:
acquiring a current first question statement and historical dialogue information associated with the first question statement;
acquiring, from a knowledge base, a first knowledge item associated with the first question statement and a second knowledge item having a question-answer relationship with the first knowledge item;
obtaining a first reply statement output by a generative model by inputting the first question statement, the first knowledge item, and the historical dialogue information into the generative model;
evaluating the first reply statement based on the first question statement, the first knowledge item, and the second knowledge item; and
outputting the first reply statement in response to the first reply statement passing evaluation.

According to a second aspect of the present disclosure, an electronic device is provided. The electronic device includes: at least one processor; and a memory communicatively coupled to the at least one processor; in which the at least one processor is configured to:
acquire a current first question statement and historical dialogue information associated with the first question statement;
acquire, from a knowledge base, a first knowledge item associated with the first question statement and a second knowledge item having a question-answer relationship with the first knowledge item;
obtain a first reply statement output by a generative model by inputting the first question statement, the first knowledge item, and the historical dialogue information into the generative model;
evaluate the first reply statement based on the first question statement, the first knowledge item, and the second knowledge item; and output the first reply statement in response to the first reply statement passing evaluation.

According to a fourth aspect of the present disclosure, a non-transitory computer readable storage medium, having computer instructions stored thereon, which causes a computer to perform a method for generating a dialogue. The method includes:
acquiring a current first question statement and historical dialogue information associated with the first question statement;
acquiring, from a knowledge base, a first knowledge item associated with the first question statement and a second knowledge item having a question-answer relationship with the first knowledge item;
obtaining a first reply statement output by a generative model by inputting the first question statement, the first knowledge item, and the historical dialogue information into the generative model;
evaluating the first reply statement based on the first question statement, the first knowledge item, and the second knowledge item; and
outputting the first reply statement in response to the first reply statement passing evaluation.

### BRIEF DESCRIPTION OF THE DRAWINGS

The above and/or additional aspects and advantages of the present disclosure will become obvious and easy to understand from the following description of the embodiments in conjunction with the accompanying drawings. The accompanying drawings are used for a better understanding of the solution and do not constitute a limitation of the present disclosure, in which,

FIG. 1 is a flowchart illustrating a method for generating a dialogue according to an embodiment of the present disclosure.

FIG. 2 is a flowchart illustrating a method for generating a dialogue according to another embodiment of the present disclosure.

FIG. 3 is a flowchart illustrating a method for generating a dialogue according to another embodiment of the present disclosure.

FIG. 4 is a flowchart illustrating a method for generating a dialogue according to another embodiment of the present disclosure.

FIG. 5 is a flowchart illustrating a method for generating a dialogue according to another embodiment of the present disclosure.

FIG. 6 is a block diagram illustrating an apparatus for generating a dialogue according to an embodiment of the present disclosure.

FIG. 7 is a block diagram illustrating an example of an electronic device suitable for implementing an embodiment of the present disclosure.

### DETAILED DESCRIPTION

Exemplary embodiments of the present disclosure are described hereinafter in conjunction with the accompanying drawings, which include various details of the embodiments of the present disclosure in order to aid in understanding, and which should be considered exemplary only. Accordingly, one of ordinary skill in the art should recognize that various changes and modifications can be made to the embodiments described herein without departing from the scope and spirit of the present disclosure. Similarly, descriptions of well-known features and structures are omitted from the following description for the sake of clarity and brevity.

Embodiments of the present disclosure relate to the technical field of artificial intelligence, such as natural language processing, large model, and deep learning, etc.

Artificial Intelligence, abbreviated as AI in English, is a new technical science that studies and develops theories, methods, technologies and application systems for simulating, extending and expanding human intelligence.

Natural language processing (NLP) is an important direction in the fields of computer science and artificial intelligence. The NLP studies various theories and methods that enable effective communication between humans and computers using natural language. The NLP is a subject that takes language as its object and uses computer technology to analyze, understand, and process natural language. The NLP regards the computers as powerful tools for language research, quantitatively studies language information with the support of computers, and provides language descriptions that can be shared between humans and computers.

Large Model, also called as Foundation Model, refers to a machine learning model with a large number of parameters and complex structures, capable of processing massive amounts of data and completing various complex tasks, such as natural language processing, computer vision, speech recognition, etc. Large language model is a natural language processing model with large-scale parameters and computing capabilities, which can be trained through a large amount of data and parameters to generate human like text or answer natural language questions.

Deep learning is to learn internal laws and representation levels of sample data. Information obtained in these learning processes is of great help to interpretation of data such as words, images, and sounds. An ultimate goal of the deep learning is to enable machines to have an ability of analysis and learning like people, and can recognize data such as words, images, and sounds.

In the technical solution of the disclosure, acquisition, storage, usage, processing, transmission, provision, disclosure and the like of the involved user personal information all comply with the provisions of relevant laws and regulations, and do not violate public order and good customs.

A method and an apparatus for generating a dialogue, and an electronic device, and a storage medium according to embodiments of the present disclosure are described below with reference to the accompanying drawings.

It should be noted that a subject for executing the method generating a dialogue in this embodiment may be an apparatus for generating a dialogue, which can be implemented by software and/or hardware. The apparatus may be provided in an electronic device, including but not limited to a terminal, a server, etc. In an embodiment of the present disclosure, the apparatus for generating the dialogue being configured into a dialogue system is taken as an example for explanation.

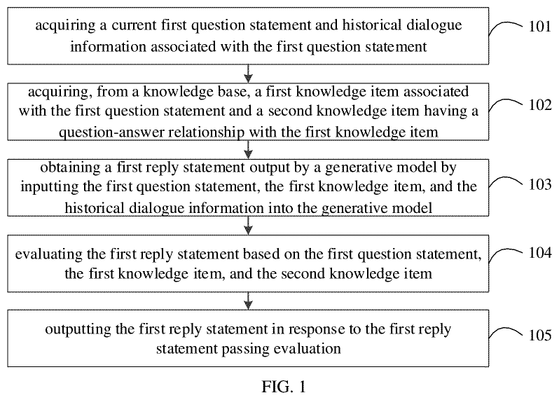

FIG. 1 is a flowchart illustrating a method for generating a dialogue according to an embodiment of the present disclosure.

As shown in FIG. 1, the method includes the following blocks.

At block S101, a current first question statement and historical dialogue information associated with the first question statement are acquired.

The first question statement may be a question statement received by a dialogue system in a dialogue interface interacting with any user.

In an embodiment of the present disclosure, in order to ensure coherence of the dialogue, a context understanding module in a system for generating a dialogue can also maintain historical memory of the dialogue by storing the historical dialogue information between each user and the dialogue system. This may be achieved by a structure such as a memory network or a recurrent neural network (such as long short-term memory (LSTM)).

In an embodiment of the present disclosure, the dialogue system may obtain the historical dialogue information associated with the first question statement from historical dialogue records of a dialogue interface to which the first question statement belongs after receiving the last input of the first question statement from any user.

At block S102, a first knowledge item associated with the first question statement and a second knowledge item having a question-answer relationship with the first knowledge item are acquired from a knowledge base.

The knowledge item refers to an individual element or unit that constitute a basic knowledge of a certain field, subject, or topic, which can be a definition, a fact, a concept, a theory, a formula, etc. In a knowledge base, respective knowledge items can be stored in the form of a knowledge graph, and different knowledge items may have a relationship with each other, such as a question-answer relationship, a cause-effect relationship, a temporal relationship, etc.

In addition, the question-answer relationship refers to a logical association between two knowledge items, such as “question-answer” or “request-response”. In the question-answer relationship, one knowledge item represents a question, request, or query, while the other knowledge item is a direct answer or response to the question, request, or query.

It should be noted that in an embodiment of the present disclosure, a similarity between the first question statement and each of knowledge items in the knowledge base may be calculated, and one or more knowledge items with higher similarity may be determined as one or more first knowledge items associated with the first question statement. Alternatively, the first knowledge item associated with the first question statement may be obtained from the knowledge base by means of other methods, such as calculating a distance between word vectors in the question statement and the knowledge item, which will not be limited in the disclosure.

In an embodiment of the present disclosure, after receiving the first question statement currently input by the user, the dialogue system may retrieve at least one first knowledge item related to the first question statement from the knowledge base in the system based on the first question statement. Then, the system may obtain, based on a relationship between respective knowledge items in the knowledge base, the second knowledge item having the question-answer relationship with each first knowledge item from the knowledge base.

It should be noted that in the present disclosure, information included in knowledge bases corresponding to respective dialogue systems applied to different scenarios may be different. For dialogue systems in different application fields, such as finance, healthcare, education, etc., relevant field knowledge may be acquired and organized, such as professional terminology, common Q&A pairs, and expert knowledge, to build a knowledge base. Then, natural language processing technologies may be used to preprocess acquired text information, such as cleaning, segmentation, and annotation, and different knowledge items are stored in the knowledge base.

At block S103, a first reply statement output by a generative model is obtained by inputting the first question statement, the first knowledge item, and the historical dialogue information into the generative model.

The generative models may be any type of model capable of generating new text based on input text, such as a pre-trained language model based on multi-layer transformer encoder (BERT, bidirectional encoder representations from transformers), or a generative pre-trained (GPT) model.

In an embodiment of the present disclosure, since the generative model learns rich language knowledge and generation ability by large-scale pre-training, the first reply statement that matches a current dialogue scenario and user requirements can be contrapuntally generated based on the input first question statement, the first knowledge item, and the historical dialogue information.

It should be noted that the generative model may be a deep learning model, such as the BERT in Transformer architecture or the GPT, etc., which can deeply parse the first question statement. The generative model may capture long-distance dependencies and semantic features in the first question statement through self-attention mechanisms and positional encoding, etc., providing rich semantic information for subsequent reply statement generation tasks and effectively improving a quality of the output statement.

It should be noted that in some possible implementations, there may be many first knowledge items or too much text information in the first knowledge items. When inputting these first knowledge items into the generative model, it may cause model burden and affect the quality and a generation efficiency of the reply statement. Therefore, before inputting the first question statement, the first knowledge items, and the historical dialogue information into the generative model, the first knowledge items may also be processed first to improve the generation efficiency of the generative model and the quality of the output reply. For example, a contribution degree of each first knowledge item in reply generation may be determined, and then the contribution degree may be input together into the generative model to generate the reply statement. Alternatively, information in the first knowledge item may be deleted or reduced, and only important information in the first knowledge item can be input into the generative model for generating the reply statements, reducing the amount of data analyzed by the generative model.

At block S104, the first reply statement is evaluated based on the first question statement, the first knowledge item, and the second knowledge item.

It should be noted that after obtaining the first reply statement output by the generative model, in order to improve the accuracy and depth of the dialogue reply, an evaluation module in the dialogue system may use knowledge in the knowledge base to verify and evaluate the first reply statement before sending it to the user, to ensure that the information in the first reply statement is accurate and in compliance with field norms.

In an embodiment of the present disclosure, a plurality of methods can be used to evaluate the first reply statement. For example, the first question statement, the first knowledge item, the second knowledge item, and the first reply statement may be input into any existing evaluation model to directly obtain an evaluation result output by the evaluation model. Alternatively, a similarity between the first question statement and the first knowledge item, as well as a similarity between the second knowledge item and the first reply statement, may be calculated, and an evaluation result may be determined by a difference between the two similarities. The present disclosure does not limit the evaluation method.

Alternatively, the first similarity between the first question statement and the first knowledge item, as well as the second similarity between the first reply statement and the second knowledge item, may be determined. In a case where the difference between the first similarity and the second similarity is less than a distance threshold, it is determined that the first reply statement passes evaluation.

The distance threshold may be set according to an evaluation accuracy requirement in a practical application. The higher the accuracy requirement, the smaller the distance threshold should be.

It should be noted that the first similarity may be determined by calculating a distance between a vector of the first question statement and a vector of the second knowledge item, or calculating a semantic similarity between the first question statement and the second knowledge item, etc., which will not be limited in the present disclosure. The calculation method for the second similarity is the similar as the calculation method for the first similarity.

In an embodiment of the present disclosure, after obtaining the first similarity and the second similarity, since the first knowledge item is associated with the first question statement, a value of the first similarity is sufficiently large. Therefore, in a case where the difference between the first similarity and the second similarity is less than the distance threshold, it may be determined that a value of the second similarity is also relatively large, that is, the first reply statement conforms to a conventional response knowledge content in the current field and is relatively reliable. Therefore, it can be determined that the first reply statement passes the evaluation. Thus, the reply statement may be evaluated by calculating the difference between the similarities, the accuracy and reliability of the generated reply statement are ensured, and the quality of intelligent dialogue is improved.

At block S105, the first reply statement is output in response to the first reply statement passing evaluation.

In an embodiment of the present disclosure, in a case where the first reply statement passes the evaluation, it can be considered that the first reply statement currently output by the generative model not only conforms to user intention, but also conforms to the professional knowledge in the current field. Therefore, the accuracy of the first reply statement is relatively high, and an output of the generative model can be sent to the user in an interface of the dialogue system to answer the first question statement.

It should be noted that in a case where the first reply statement fails the evaluation, it may indicate that the current first reply statement does not match the field knowledge and has low accuracy. Therefore, it is required to update the reply statement output by the generative model until the reply statement passes the evaluation and is output to the user. The update of the reply statement may be achieved by inputting discovered problems during the evaluation process or the second knowledge item into the generative model, and obtaining the new reply statements output by the model.

In this embodiment, the current first question statement and the historical dialogue information associated with the first question statement are acquired. The first knowledge item associated with the first question statement and the second knowledge item having the question-answer relationship with the first knowledge item are acquired from the knowledge base, the first reply statement output by the generative model is obtained by inputting the first question statement, the first knowledge item, and the historical dialogue information into the generative model. The first reply statement is evaluated based on the first question statement, the first knowledge item, and the second knowledge item. The first reply statement is output in response to the first reply statement passing the evaluation. Therefore, by combining professional knowledge in the field related to the user question statement and the historical dialogue information, the reply statement is generated automatically, achieving fusion of a dialogue reply and field knowledge, improving a quality of the reply statement, and ensuring coherence and consistency of the dialogue. With evaluating the generated reply statement, a reply accuracy has been improved, effectively reducing grammar errors and illogical situations in the reply statement, and optimizing user experience.

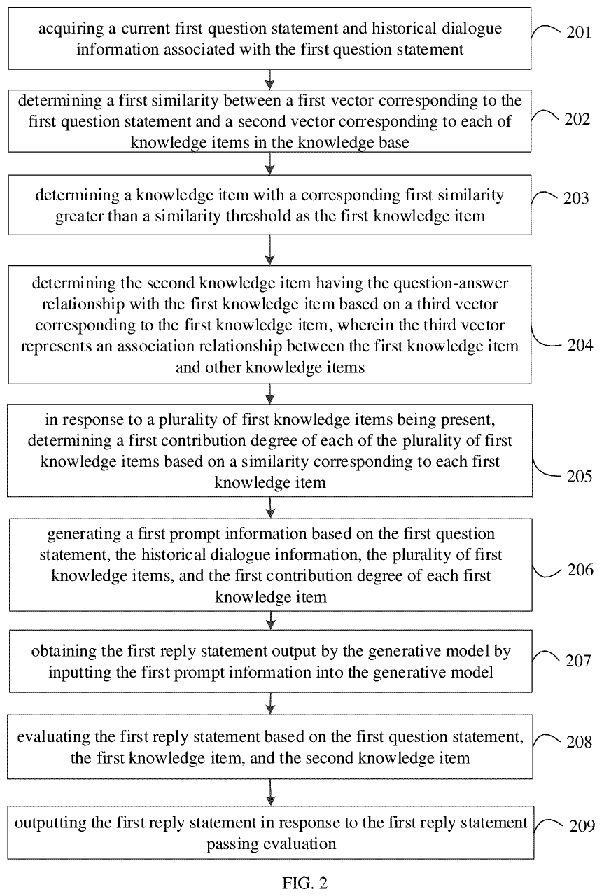

FIG. 2 is a flowchart illustrating a method for generating a dialogue according to another embodiment of the present disclosure.

As shown in FIG. 2, the method includes the following blocks.

At block S201, a current first question statement and historical dialogue information associated with the first question statement are acquired.

The description of S201 can be specifically referred to in the above embodiments, and will not be repeated here.

At block S202, a first similarity between a first vector corresponding to the first question statement and a second vector corresponding to each of knowledge items in the knowledge base are determined.

In an embodiment of the present disclosure, embedding technologies in deep learning (such as neural network-based word embedding technologies like Word2Vec, BERT, etc.) may be used to encode the first question statement and each knowledge item respectively, the first vector corresponding to the first question statement and the second vector corresponding to each knowledge item are obtained.

In an embodiment of the present disclosure, the first similarity between the first vector and each second vector may be calculated in any method. For example, a cosine similarity between the first vector and the second vector may be calculated. Alternatively, a Euclidean distance between the first vector and the second vector may be calculated, where the smaller the distance, the greater the similarity. Alternatively, other feasible similarity calculation methods can also be used, which will not limited in the disclosure.

At block S203, a knowledge item with a corresponding first similarity greater than a similarity threshold is determined as the first knowledge item.

The similarity threshold may be customized according to practical application requirements, experience and other factors. The present disclosure does not limit this value.

In an embodiment of the present disclosure, after determining the first similarity between the first vector and each second vector, each first similarity can be compared with the similarity threshold. When the first similarity is greater than the similarity threshold, it may be determined that the knowledge item corresponding to the first similarity has a strong correlation with the first question statement, this knowledge item may be determined as the first knowledge item used to generate the reply statement.

It should be noted that due to the possibility of the first similarities corresponding to a plurality of knowledge items greater than the similarity threshold, there may also be the plurality of first knowledge items.

At block S204, the second knowledge item having the question-answer relationship with the first knowledge item is determined based on a third vector corresponding to the first knowledge item, wherein the third vector represents an association relationship between the first knowledge item and other knowledge items.

The third vector is used to represent the association relationship between the first knowledge item and other knowledge items.

It should be noted that, when building the knowledge base, knowledge graph embedding technologies, such as translating embeddings for modeling multi-relational data (TransE), knowledge graph embeddings based on complex space (Rotate, relational rotation in complex space), etc., can be used, and entities in various knowledge items and relationships between the knowledge items are mapped to a low dimensional vector space, forming a knowledge graph for subsequent computation and inference.

In an embodiment of the present disclosure, since the relationship between two knowledge items in the knowledge base may be not only a question-answer relationship, but also other relationships, after determining the first knowledge item associated with the first question statement, another knowledge item connected to the third vector corresponding to each first knowledge item may be determined based on the knowledge graph in the knowledge base. Then, relationships represented by the third vector may be filtered, and the knowledge item connected to the third vector representing the question-answer relationship can be determined as the second knowledge item.

In an embodiment of the present disclosure, the first knowledge item associated with the question statement input by the user is determined by calculating a vector similarity between the user input statement and the knowledge item in the knowledge base. Based on the relationship represented by the vectors between each knowledge item in the knowledge base, the second knowledge item with the relationship between the second knowledge item and the first knowledge item as the question-answer relationship is obtained. This may improve the rationality and reliability of field knowledge used to generate the reply statement and provide a data basis for enhancing an ability of the dialogue system to handle complex problems.

At block S205, in response to a plurality of first knowledge items being present, a first contribution degree of each of the plurality of first knowledge items is determined based on a similarity corresponding to each first knowledge item.

In an embodiment of the present disclosure, when there are the plurality of first knowledge items, all first knowledge items are directly input into the generative model for generating the reply statement. There is no primary or secondary relationship between the plurality of first knowledge items, and the generative model needs to parse each of the first knowledge items to the same extent, which may result in wastage of computing resources and affect the quality of the generated statement. Therefore, the similarity between each first knowledge item and the first question statement may be determined as the first contribution degree of the first knowledge item. The higher the similarity, the more the first knowledge item conforms to the user intention, indicating that the first knowledge item is more important for generating the reply statement, that is, the higher the first contribution degree.

At block S206, a first prompt information is generated based on the first question statement, the historical dialogue information, the plurality of first knowledge items, and the first contribution degree of each first knowledge item.

The first prompt information is used to indicate the reply statement generated by the generative model combining the contribution degree of each knowledge item.

In an embodiment of the present disclosure, a template for generating the first prompt information may be pre-set in the dialogue system. After obtaining the first question statement, the historical dialogue information, the plurality of first knowledge items, and the first contribution degree of each first knowledge item, the first question statement, the historical dialogue information, the plurality of first knowledge items, and the first contribution degree of each first knowledge item may be respectively filled into the template, and the first prompt information may be obtained.

At block S207, the first reply statement output by the generative model is obtained by inputting the first prompt information into the generative model.

In an embodiment of the present disclosure, after generating the prompt information based on various information used to generate the reply statement, the prompt information is input into the generative model to instruct the model to generate the reply statement. The generative model may identify a key angle that need to be emphasized when generating the reply statement, and focus on parsing and processing of the knowledge item. This may improve a utilization rate of computing resources, enhance understandings and a processing efficiency of the generative model for input information, reduce misunderstandings, and ensure the reliability of the output reply statement.

In an embodiment of the present disclosure, when there are the plurality of first knowledge items, the contribution degree of each first knowledge item respective to the generation of the reply statement is determined. Then, the first question statement, the historical dialogue information, the plurality of first knowledge items, and the contribution degree of each first knowledge item are fused to generate the first prompt information. The first prompt information is input into the generative model to obtain the first reply statement output by the generative model. Thus, effective fusion of user input and field knowledge has been achieved, which may not only enhance the amount of information of the input data of the model, but also enable the model to more accurately understand the user intention, improve the accuracy and reliability of the generated reply statement.

At block S208, the first reply statement is evaluated based on the first question statement, the first knowledge item, and the second knowledge item.

At block S209, the first reply statement is output in response to the first reply statement passing evaluation.

The description of S208 and S209 can be specifically referred to in the above embodiments, and will not be repeated here.

In this embodiment, the first knowledge item associated with the question statement input by the user is determined by calculating a vector similarity between the user input statement and the knowledge item in the knowledge base. Based on the relationship represented by the vectors between each knowledge item in the knowledge base, the second knowledge item with the relationship between the second knowledge item and the first knowledge item as the question-answer relationship is obtained. This may improve the rationality and reliability of field knowledge used to generate the reply statement and provide a data basis for enhancing an ability of the dialogue system to handle complex problems. When there are the plurality of first knowledge items, the contribution degree of each first knowledge item respective to the generation of the reply statement is determined. Then, the first question statement, the historical dialogue information, the plurality of first knowledge items, and the contribution degree of each first knowledge item are fused to generate the first prompt information. The first prompt information is input into the generative model to obtain the first reply statement output by the generative model. Thus, effective fusion of user input and field knowledge has been achieved, which may not only enhance the amount of information of the input data of the model, but also enable the model to more accurately understand the user intention, improve the accuracy and reliability of the generated reply statement.

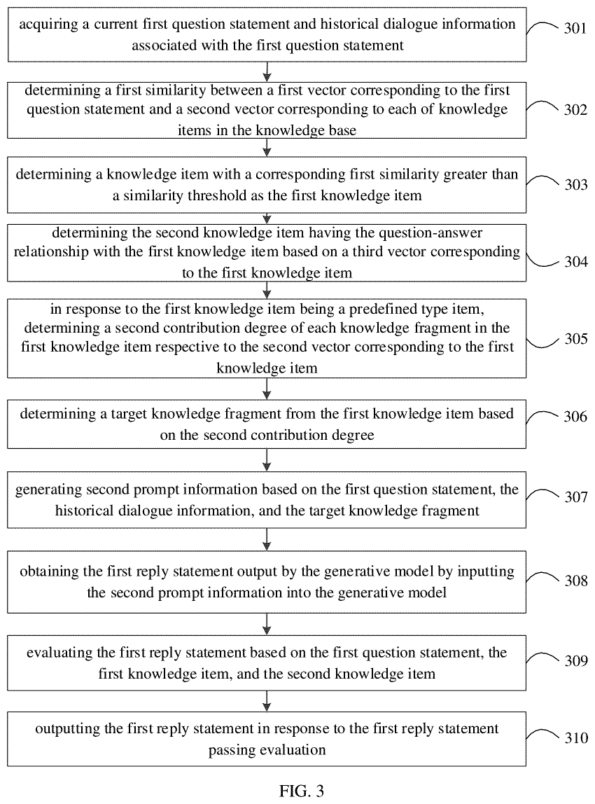

FIG. 3 is a flowchart illustrating a method for generating a dialogue according to another embodiment of the present disclosure.

As shown in FIG. 3, the method includes the following blocks.

At block S301, a current first question statement and historical dialogue information associated with the first question statement are acquired.

At block S302, a first similarity between a first vector corresponding to the first question statement and a second vector corresponding to each of knowledge items in the knowledge base are determined.

At block S303, a knowledge item with a corresponding first similarity greater than a similarity threshold is determined as the first knowledge item.

At block S304, the second knowledge item having the question-answer relationship with the first knowledge item is determined based on a third vector corresponding to the first knowledge item.

The description of S301 to S304 can be specifically referred to in the above embodiments, and will not be repeated here.

At block S305, in response to the first knowledge item being a predefined type item, a second contribution degree of each knowledge fragment in the first knowledge item respective to the second vector corresponding to the first knowledge item is determined.

The predefined type item refers to knowledge item that includes a large amount of information and is a relatively complex type, such as an article or content including multiple paragraphs of text. Each paragraph or sentence of content in the predefined type item may be considered as a knowledge fragment in that knowledge item.

In an embodiment of the present disclosure, after obtaining the first knowledge item, it may determine whether each first knowledge item is the predefined type item. In a case where any first knowledge item is the predefined type item, due to the large amount of information in the first knowledge item, there may be redundant or noisy information, which may affect the quality of the generated reply statement. Therefore, by using attention mechanisms and other techniques, the second contribution of each knowledge fragment in the first knowledge item respective to the second vector corresponding to the first knowledge item is determined, to select the content in the first knowledge item that plays a key role in generating the reply statement.

At block S306, a target knowledge fragment from the first knowledge item is determined based on the second contribution degree.

The target knowledge fragment refers to the content in the first knowledge item that plays a key role in generating the reply statement.

In an embodiment of the present disclosure, a contribution threshold can be pre-set in the dialogue system according to actual application requirements. Then, after determining the second contribution corresponding to each knowledge fragment in the first knowledge item, the second contribution is compared with the contribution threshold. The knowledge fragment corresponding to the second contribution greater than the contribution threshold may be determined as the target knowledge fragment in the first knowledge item. Alternatively, the knowledge fragment corresponding to the maximum value of all second contributions may be determined as the target fragment in the first knowledge item, etc. The present disclosure does not limit this.

At block S307, second prompt information is generated based on the first question statement, the historical dialogue information, and the target knowledge fragment.

The second prompt information is used to indicate the reply statement generated by the generative model combining the target knowledge fragment and other contents.

In an embodiment of the present disclosure, a template for generating the second prompt information may be pre-set in the dialogue system. After obtaining the first question statement, the historical dialogue information, and the target knowledge fragment, the first question statement, the historical dialogue information, and the target knowledge fragment may be respectively filled into the template to obtain the second prompt information.

At block S308, the first reply statement output by the generative model is obtained by inputting the second prompt information into the generative model.

In an embodiment of the present disclosure, by obtaining the knowledge fragment with high contribution from the knowledge item associated with the user input statement, inputting the knowledge fragment into the generative model, and obtaining the reply statement, the fragment used to generate the reply statement in each knowledge item associated with the user input statement may be dynamically adjusted, reducing resources consumed by calculation of the generative model, improving the efficiency of generating the reply statement, and further improving the quality of the reply statement.

At block S309, the first reply statement is evaluated based on the first question statement, the first knowledge item, and the second knowledge item.

At block S310, the first reply statement is output in response to the first reply statement passing evaluation.

The description of S309 and S310 can be specifically referred to in the above embodiments, and will not be repeated here.

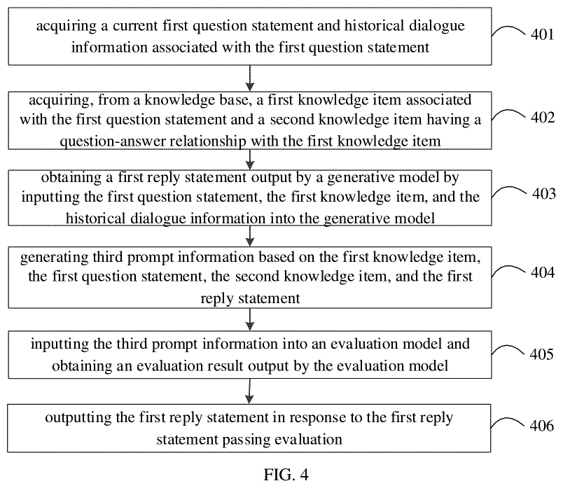

FIG. 4 is a flowchart illustrating a method for generating a dialogue according to another embodiment of the present disclosure.

As shown in FIG. 4, the method includes the following blocks.

At block S401, a current first question statement and historical dialogue information associated with the first question statement are acquired.

At block S402, a first knowledge item associated with the first question statement and a second knowledge item having a question-answer relationship with the first knowledge item are acquired from a knowledge base.

At block S403, a first reply statement output by a generative model is obtained by inputting the first question statement, the first knowledge item, and the historical dialogue information into the generative model.

The description of S401 to S403 can be specifically referred to in the above embodiments, and will not be repeated here.

At block S404, third prompt information is generated based on the first knowledge item, the first question statement, the second knowledge item, and the first reply statement.

The third prompt information is used to instruct verification of the evaluation model for an accuracy and standardization of the reply statement.

In an embodiment of the present disclosure, a template for generating the third prompt information may be predefined in the dialogue system. After obtaining the first knowledge item, the first question statement, the second knowledge item, and the first reply statement, the first knowledge item, the first question statement, the second knowledge item, and the first reply statement are respectively filled into the template to obtain the third prompt information.

It should be noted that considering the different text generation capabilities of different generative models, the reply statements output by different generative models may include diverse data content. Therefore, evaluating the first reply statement using only the second knowledge item having the question-answer relationship with the first knowledge item may not accurately verify the accuracy of all content in the first reply statement. Therefore, in the disclosure, other knowledge items may also be acquired from the knowledge base to enrich the third prompt information for evaluating the first reply statement.

Alternatively, a third knowledge item associated with the first reply statement is acquired from the knowledge base.

In an embodiment of the present disclosure, a semantic similarity between the first reply statement and each knowledge item in the knowledge base may be calculated, and one or more knowledge items with the semantic similarity higher than a certain threshold may be determined as one or more third knowledge items associated with the first reply statement. Alternatively, the third knowledge item associated with the first reply statement may be obtained from the knowledge base by means of other method, such as calculating a distance between word vectors in the first reply statement and each knowledge item. The present disclosure does not limit this.

A fused knowledge item and a weight of the fused knowledge item are obtained by fusing the third knowledge item and the second knowledge item.

The fusion method may include performing duplicates removing and merging on the third knowledge item and the second knowledge item.

The weight of the fused knowledge item is used to indicate a degree of emphasis of each of different knowledge items in the evaluation model when evaluating the reply statement.

It should be noted that the third knowledge item may have one or more, and the second knowledge item may also have one or more, and there may be situations where the second knowledge item is the same as the third knowledge item. Therefore, after performing duplicates removing and merging on each third knowledge item and each second knowledge item, the fused knowledge item may be one or more, and may be the same as the second knowledge item or the third knowledge item.

In an embodiment of the present disclosure, after removing duplicate content between the third knowledge item and the second knowledge item, merging all content between the third knowledge item and the second knowledge item, and obtaining the fused knowledge item, the weight of the fused knowledge item may be determined in various ways, such as calculating a similarity between the fused knowledge item and the first reply statement to determine the weight. The higher the similarity, the higher the weight. Alternatively, the weight may be determined based on the number of occurrences of the fused knowledge item in the second knowledge item and the third knowledge item, etc.

The third prompt information is generated based on the first knowledge item, the first question statement, the first reply statement, the fused knowledge item, and the weight of the fused knowledge item.

In an embodiment of the present disclosure, the third knowledge item associated with the first reply statement in the knowledge base is fused with the second knowledge item to obtain the fused knowledge item and its corresponding weight. Then, the fused knowledge item and its corresponding weight, together with the first knowledge item, the first question statement, and the first reply statement, are used to generate the prompt information to instruct the evaluation model to evaluate the first reply statement. Thus, richness of the prompt information for evaluation may be improved, thereby enhancing the reliability and accuracy of the evaluation result of the reply statement.

Alternatively, when determining the weight of the fused knowledge item, a third similarity between the fused knowledge item and the first reply statement, and the number of occurrences of the fused knowledge item in the second knowledge item and the third knowledge item may be determined.

In an embodiment of the present disclosure, the third similarity may be obtained by calculating the semantic similarity between the fused knowledge item and the first reply statement. Alternatively, the third similarity may be obtained by calculating the distance between a vector of the fused knowledge item and a vector of the first reply statement. The smaller the distance, the higher the similarity. Alternatively, other methods for calculating a similarity between text may also be used, and the present disclosure does not limit the specific method.

It can be understood that in some possible embodiments, there may be a situation where the second knowledge item is the same as the third knowledge item, or where the third knowledge item includes the second knowledge item, etc. At this case, the fused knowledge item may be either the second knowledge item or the third knowledge item, or the fused knowledge item may have occurred in both the second knowledge item and the third knowledge item. Therefore, the number of occurrences of the fused knowledge item may be obtained by determining the number of the knowledge items same as the fused knowledge item in both the second knowledge item and the third knowledge item.

It should be noted that when the fused knowledge item occurs in both the second knowledge item and the third knowledge item, the number of occurrences is denoted as 2 times. This indicates that the fused knowledge item not only has the question-answer relationship with the first knowledge item, but also is associated with the generated first reply statement, which has a relatively high impact on the evaluation result.

The weight of the fused knowledge item may be determined based on the third similarity and/or the number of occurrences.

In an embodiment of the present disclosure, the weight may be determined only based on the third similarity. The higher the third similarity, the more the corresponding fused knowledge item conforms to the filed knowledge specification corresponding to the reply statement, and the higher the weight of the fused knowledge item. Alternatively, the weight may also be determined based only on the number of occurrences. The higher the number of occurrences, the stronger the correlation between the corresponding fused knowledge item and the reply statement, and the better the evaluation effect on the reply statement, that is, the higher the weight of the fused knowledge item. Alternatively, the weight of the fused knowledge item may be determined by both the third similarity and the number of occurrences.

In an embodiment of the present disclosure, the weight of the fused knowledge item is determined by calculating the similarity and the number of occurrences of the fused knowledge item, thereby improving the reliability of the weight of the fused knowledge item and enhancing the accuracy and reliability of the evaluation result obtained based on the weight.

At block S405, the third prompt information is input into an evaluation model and obtaining an evaluation result output by the evaluation model.

The evaluation model may be any existing model used to verify the accuracy and standardization of text. The evaluation result generated by the evaluation model may include error types (such as semantic inconsistency, inconsistency with field knowledge, etc.), error locations, and the like in the first reply statement, which is not limited in the disclosure.

It should be noted that in a case where the evaluation result corresponding to the first reply statement fails to pass, the dialogue system may update the input content of the generative model based on the evaluation result to ensure a smooth progress of the dialogue.

Optionally, in response to the first reply statement failing to pass the evaluation, a second reply statement output by the generative model is obtained by inputting the evaluation result corresponding to the first reply statement into the generative model, and then it is returned to perform an evaluation operation based on the second reply statement, until a reply statement that passes the evaluation is obtained and output.

In an embodiment of the present disclosure, the evaluation result corresponding to the first reply statement that fails to pass the evaluation may be input into the generative model to instruct the generative model to output a new one compared to the previously generated first reply statement based on shortcomings included in the evaluation result, so as to obtain an updated second reply statement. Then the second reply statement is evaluated, and if the second reply statement passes the evaluation, the second reply statement may be output to the user. If the evaluation result of the second reply statement still fails to pass the evaluation, the new evaluation result is input into the generative model to obtain a new reply statement until the generated reply statement can pass the evaluation. Therefore, by utilizing the evaluation result of the reply statements that fails to pass the evaluation, the generative model may be instructed to output the new reply statement, which may further improve the reliability of the reply statement, enhance the quality of the dialogue, and ensure the coherence of the dialogue.

At block S406, the first reply statement is output in response to the first reply statement passing evaluation.

The description of S406 can be specifically referred to in the above embodiments, and will not be repeated here.

In this embodiment, by utilizing the first knowledge item, the first question statement, the second knowledge item, and the first reply statement to generate the third prompt information, and then instructing the evaluation model to output the evaluation result of the first reply statement, automatic evaluation and verification of the reply statement may be achieved, the evaluation efficiency of the reply statement and the reliability of the evaluation result may be improved, the quality of the dialogue may be improved.

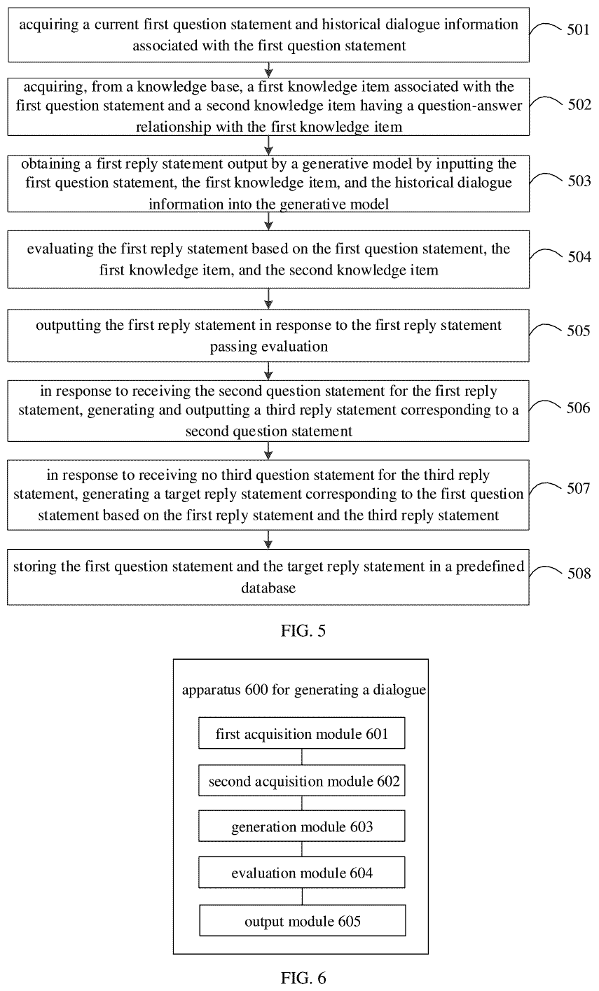

FIG. 5 is a flowchart illustrating a method for generating a dialogue according to another embodiment of the present disclosure.

As shown in FIG. 5, the method includes the following blocks.

At block S501, a current first question statement and historical dialogue information associated with the first question statement are acquired.

At block S502, a first knowledge item associated with the first question statement and a second knowledge item having a question-answer relationship with the first knowledge item are acquired from a knowledge base.

At block S503, a first reply statement output by a generative model is obtained by inputting the first question statement, the first knowledge item, and the historical dialogue information into the generative model.

At block S504, the first reply statement is evaluated based on the first question statement, the first knowledge item, and the second knowledge item.

At block S505, the first reply statement is output in response to the first reply statement passing evaluation.

The description of S501 to S505 can be specifically referred to in the above embodiments, and will not be repeated here.

At block S506, in response to receiving the second question statement for the first reply statement, a third reply statement corresponding to a second question statement is generated and output.

In an embodiment of the present disclosure, after the dialogue system outputs the first reply statement to the user, the user may have questions about the first reply statement and may input a new second question statement in the dialogue interface. Therefore, the dialogue system may receive the second question statement for the first reply statement, then the dialogue system may obtain the third reply statement which is output by the generative model and passes the evaluation according to the method described in the above embodiment, and output the third reply statement to the current dialogue interface.

At block S507, in response to receiving no third question statement for the third reply statement, a target reply statement corresponding to the first question statement is generated based on the first reply statement and the third reply statement.

In an embodiment of the present disclosure, when the third reply statement is output to the dialogue interface and no third question statement for the third reply statement is received, it may be determined that the first reply statement and the third reply statement can meet the user requirements and solve the user problem (i.e. the problem corresponding to the first question statement), then the first reply statement together with the third reply statement may be determined as the target reply statement corresponding to the first question statement.

At block S508, the first question statement and the target reply statement are stored in a predefined database.

Data in the predefined database is used to perform update training on the generative model.

In an embodiment of the present disclosure, the first question statement and its corresponding target reply statement may be stored in pairs in the predefined database. When the data in the predefined database reaches a certain amount or a predefined update time interval is arrived, the generative model may be updated and trained using the data in the predefined database.

In this embodiment, in a case of receiving the second question statement for the first reply statement, the third reply statement corresponding to the second question statement is generated and output. Then, in the absence of the third question statement for the third reply statement, the target reply statement corresponding to the first question statement is generated based on the first reply statement and the third reply statement. And the first question statement and the target reply statement are stored in the predefined database. Therefore, by iteratively optimizing the generated reply statement based on user feedback, and adjusting and training parameters and strategies of the generative module based on the question statement and its final optimized reply content, the dialogue system may continuously adapt to a new dialogue scenario and user requirements, and an overall performance of the dialogue system may be improved.

FIG. 6 is a block diagram illustrating an apparatus for generating a dialogue according to an embodiment of the present disclosure.

As shown in FIG. 6, the apparatus includes:
a first acquisition module 601, configured to acquire a current first question statement and historical dialogue information associated with the first question statement;
a second acquisition module 602, configured to acquire, from a knowledge base, a first knowledge item associated with the first question statement and a second knowledge item having a question-answer relationship with the first knowledge item;
a generation module 603, configured to obtain a first reply statement output by a generative model by inputting the first question statement, the first knowledge item, and the historical dialogue information into the generative model;
an evaluation module 604, configured to evaluate the first reply statement based on the first question statement, the first knowledge item, and the second knowledge item; and
an output module 605, configured to output the first reply statement in response to the first reply statement passing evaluation.

Optionally, the second acquisition module 603 is configured to:
determine a first similarity between a first vector corresponding to the first question statement and a second vector corresponding to each of knowledge items in the knowledge base;
determine a knowledge item with a corresponding first similarity greater than a similarity threshold as the first knowledge item; and
determine the second knowledge item having the question-answer relationship with the first knowledge item based on a third vector corresponding to the first knowledge item, wherein the third vector represents an association relationship between the first knowledge item and other knowledge items.

Optionally, the generation module 603 is configured to:
in response to a plurality of first knowledge items being present, determine a first contribution degree of each of the plurality of first knowledge items based on a similarity corresponding to each first knowledge item;
generate a first prompt information based on the first question statement, the historical dialogue information, the plurality of first knowledge items, and the first contribution degree of each first knowledge item; and
obtain the first reply statement output by the generative model by inputting the first prompt information into the generative model.

Optionally, the generation module 603 is configured to:
in response to the first knowledge item being a predefined type item, determine a second contribution degree of each knowledge fragment in the first knowledge item respective to the second vector corresponding to the first knowledge item;
determine a target knowledge fragment from the first knowledge item based on the second contribution degree;
generate second prompt information based on the first question statement, the historical dialogue information, and the target knowledge fragment;
obtain the first reply statement output by the generative model by inputting the second prompt information into the generative model.

Optionally, the evaluation module 604 is configured to:
determine a first similarity between the first question statement and the first knowledge item, and a second similarity between the first reply statement and the second knowledge item;
determine that the first reply statement passes the evaluation in response to a difference between the first similarity and the second similarity being less than a distance threshold.

Optionally, the evaluation module 604 is configured to:
generate third prompt information based on the first knowledge item, the first question statement, the second knowledge item, and the first reply statement;
input the third prompt information into an evaluation model and obtain an evaluation result output by the evaluation model.

Optionally, the evaluation module 604 is configured to:
receive a third knowledge item associated with the first reply statement from the knowledge base;
obtain a fused knowledge item and a weight of the fused knowledge item by fusing the third knowledge item and the second knowledge item;
generate the third prompt information based on the first knowledge item, the first question statement, the first reply statement, the fused knowledge item, and the weight of the fused knowledge item.

Optionally, the evaluation module 604 is configured to:
determine a third similarity between the fused knowledge item and the first reply statement, and the number of occurrences of the fused knowledge item in the second knowledge item and the third knowledge item;
determine the weight of the fused knowledge item based on the third similarity and/or the number of occurrences.

Optionally, the evaluation module 604 is configured to:
in response to the first reply statement failing the evaluation, obtain a second reply statement output by the generative model by inputting an evaluation result corresponding to the first reply statement into the generative model;
return to perform an evaluation operation based on the second reply statement, until an reply statement that passes the evaluation is obtained and output.

Optionally, the output module 605 is configured to:
in response to receiving the second question statement for the first reply statement, generate and output a third reply statement corresponding to a second question statement;
in response to receiving no third question statement for the third reply statement, generate a target reply statement corresponding to the first question statement based on the first reply statement and the third reply statement;
store the first question statement and the target reply statement in a predefined database, wherein data in the predefined database is used to perform update training on the generative model.

It should be noted that the above explanation and description of the method for generating the dialogue also applies to the apparatus for generating the dialogue of this embodiment, which will not be repeated here.

In this embodiment, by combining professional knowledge in the field related to the user question statement and the historical dialogue information, the reply statement is generated automatically, achieving fusion of a dialogue reply and field knowledge, improving a quality of the reply statement, and ensuring coherence and consistency of the dialogue. With evaluating the generated reply statement, a reply accuracy has been improved, effectively reducing grammar errors and illogical situations in the reply statement, and optimizing user experience.

According to embodiments of the present disclosure, which also provide an electronic device, a readable storage medium, and a computer program product.

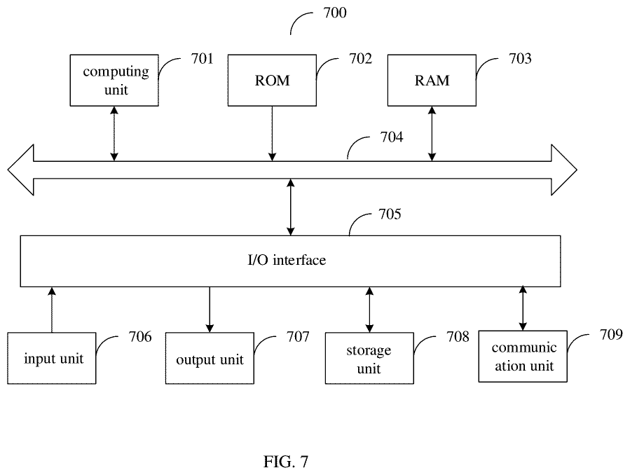

FIG. 7 is a block diagram illustrating an example of an electronic device 700 suitable for implementing an embodiment of the present disclosure. The electronic device is intended to represent various types of digital computers, such as laptop computers, desktop computers, workstations, personal digital assistants, servers, blade servers, mainframe computers, and other suitable computers. The electronic device may also represent various types of mobile apparatuses, such as personal digital assistants, cellular phones, smart phones, wearable non-intrusive flexible loads aggregation characteristic identification devices, and other similar computing devices. The components shown herein, their connections and relations, and their functions are merely examples, and are not intended to limit the implementation of the disclosure described and/or required herein.

As shown in FIG. 7, the device 700 includes a computing unit 701, configured to execute various appropriate actions and processes according to a computer program stored in a read-only memory (ROM) 702 or loaded from a storage unit 708 to a random access memory (RAM) 703. In the RAM 703, various programs and data required for the device 700 may be stored. The computing unit 701, the ROM 702 and the RAM 703 may be connected with each other by a bus 704. An input/output (I/O) interface 705 is also connected to the bus 704.

The device 700 are connected to an I/O interface 705, and includes: an input unit 706, for example, a keyboard, a mouse; an output unit 707, for example, various types of displays, speakers; a storage unit 708, for example, a magnetic disk, an optical disk; and a communication unit 709, for example, a network card, a modem, a wireless transceiver. The communication unit 709 allows the device 700 to exchange information/data through a computer network such as internet and/or various types of telecommunication networks and other devices.

The computing unit 701 may be various types of general and/or dedicated processing components with processing and computing ability. Some examples of a computing unit 701 include but not limited to a central processing unit (CPU), a graphics processing unit (GPU), various dedicated artificial intelligence (AI) computing chips, various computing units running a machine learning model algorithm, a digital signal processor (DSP), and any appropriate processor, controller, microcontroller, etc. The computing unit 701 executes various methods and processes as described above, for example, a method for protein docking. For example, in some embodiments, the method for protein docking may be further implemented as a computer software program, which is physically contained in a machine readable medium, such as the storage unit 708. In some embodiments, a part or all of the computer program may be loaded and/or installed on the device 700 via the ROM 702 and/or a communication unit 709. When the computer program is loaded on the RAM 703 and executed by the computing unit 701, one or more steps in the method for generating the dialogue as described above may be performed. Alternatively, in other embodiments, the computing unit 701 may be configured to the method for generating the dialogue in other appropriate ways (for example, by virtue of a firmware).

Various implementation modes of systems and technologies described herein may be implemented in a digital electronic circuit system, an integrated circuit system, a field programmable gate array (FPGA), a dedicated application specific integrated circuit (ASIC), a system on a chip (SOC), a complex programmable logic device (CPLD), a computer hardware, a firmware, a software, and/or combinations thereof. The implementations may include: implemented in one or more computer programs. The one or more computer programs may be executed and/or interpreted on a programmable system including at least one programmable processor. The programmable processor may be a dedicated or general-purpose programmable processor, may receive data and instructions from a storage system, at least one input device, and at least one output device, and transmit the data and the instructions to the storage system, the at least one input device, and the at least one output device.

A computer code configured to execute a method in the present disclosure may be written with one or any combination of multiple programming languages. These programming languages may be provided to a processor or a controller of a general-purpose computer, a dedicated computer, or other programmable apparatuses for data processing so that the function/operation specified in the flowchart and/or block diagram may be performed when the program code is executed by the processor or controller. A computer code may be executed completely or partly on the machine, executed partly on the machine as an independent software package and executed partly or completely on the remote machine or server.

In the embodiment of the present disclosure, a machine-readable medium may be a tangible medium that may contain or store a program intended for use in or in conjunction with an instruction execution system, an apparatus or a device. The machine-readable medium may be a machine-readable signal medium or a machine-readable storage medium. The machine-readable medium may include but not limited to an electronic, magnetic, optical, electromagnetic, infrared, or semiconductor system, apparatus or device, or any appropriate combination thereof. A more specific example of a machine readable storage medium includes an electronic connector with one or more cables, a portable computer disk, a hardware, a random access memory (RAM), a read-only memory (ROM), an EPROM programmable read-only ROM (an EPROM or a flash memory), an optical fiber device, and a compact disc read-only memory (CD-ROM), an optical storage device, a magnetic storage device, or any appropriate combination of the above.

In order to provide interaction with the user, the systems and technologies described here may be implemented on a computer, and the computer has: a display apparatus for displaying information to the user (for example, a CRT (cathode ray tube) or a LCD (liquid crystal display) monitor); and a keyboard and a pointing apparatus (for example, a mouse or a trackball) through which the user may provide input to the computer. Other types of apparatuses may further be configured to provide interaction with the user. For example, feedback provided to the user may be any form of sensory feedback (for example, visual feedback, auditory feedback, or tactile feedback). Input from the user may be received in any form (including an acoustic input, a voice input or a tactile input).

Systems and technologies described herein may be implemented in a computing system (for example, as a data server) including a background component, or a computing system (for example, an application server) including a middleware component, or a computing system including a front-end component (for example, a user computer with a graphical user interface or a web browser, and the user may interact with implementations of the systems and technologies described herein via the graphical user interface or the web browser), or in a computing system including any combination of the background component, the middleware component, or the front-end component. Components of the system may be interconnected by any form or medium of digital data communication (for example, a communication network). Examples of the communication network include a local area network (LAN), a wide area network (WAN), and an Internet.

The computer system may include a client and a server. The client and the server are generally far away from each other and generally interact with each other through a communication network. The relationship between the client and the server is generated by computer programs that run on the corresponding computer and have a client-server relationship with each other. A server may be a cloud server, also known as a cloud computing server or cloud host, which is a hosting product in the cloud computing service system to solve the problems of difficult management and weak business scalability in the traditional physical host and VPS (virtual private server) service. The server can also be a distributed system server or a server that combines blockchain.

It should be noted that steps in various forms of processes shown above may be reordered, added, or deleted. For example, steps described in the present disclosure may be executed in parallel, sequentially, or in a different order, as long as the desired result of the technical solution disclosed in the present disclosure may be achieved, which will not be limited herein.

In addition, the terms “first” and “second” are only used for descriptive purposes and cannot be understood as indicating or implying relative importance or implying the number of technical features indicated. Therefore, the feature that is limited to “first” or “second” can explicitly or implicitly include at least one feature. In description of the disclosure, the meaning of “a plurality of” refers to at least two, such as two, three, etc., unless otherwise specified. In description of the disclosure, the words “if” and “in case” used can be interpreted as “when” or “upon” or “in response to determining” or “in a case of”.

The above implementations do not constitute a limitation to the scope of protection of the disclosure. Those skilled in the art shall understand that various modifications, combinations and sub-combinations and substitutions may be made. Any modification, equivalent substitution and improvement, etc., made within the spirit and principle of the present disclosure shall be included within the scope of protection of the present disclosure.

1. A method for generating a dialogue, comprising:
acquiring a current first question statement and historical dialogue information associated with the first question statement;
acquiring, from a knowledge base, a first knowledge item associated with the first question statement and a second knowledge item having a question-answer relationship with the first knowledge item;
obtaining a first reply statement output by a generative model by inputting the first question statement, the first knowledge item, and the historical dialogue information into the generative model;
evaluating the first reply statement based on the first question statement, the first knowledge item, and the second knowledge item; and
outputting the first reply statement in response to the first reply statement passing evaluation.

2. The method according to claim 1, wherein acquiring, from the knowledge base, the first knowledge item associated with the first question statement and the second knowledge item having the question-answer relationship with the first knowledge item comprises:
determining a first similarity between a first vector corresponding to the first question statement and a second vector corresponding to each of knowledge items in the knowledge base;
determining a knowledge item with a corresponding first similarity greater than a similarity threshold as the first knowledge item; and
determining the second knowledge item having the question-answer relationship with the first knowledge item based on a third vector corresponding to the first knowledge item, wherein the third vector represents an association relationship between the first knowledge item and other knowledge items.

3. The method according to claim 2, wherein obtaining the first reply statement output by the generative model by inputting the first question statement, the first knowledge item, and the historical dialogue information into the generative model comprises:
in response to a plurality of first knowledge items being present, determining a first contribution degree of each of the plurality of first knowledge items based on a similarity corresponding to each first knowledge item;
generating a first prompt information based on the first question statement, the historical dialogue information, the plurality of first knowledge items, and the first contribution degree of each first knowledge item; and
obtaining the first reply statement output by the generative model by inputting the first prompt information into the generative model.

4. The method according to claim 2, wherein obtaining the first reply statement output by the generative model by inputting the first question statement, the first knowledge item, and the historical dialogue information into the generative model comprises:
in response to the first knowledge item being a predefined type item, determining a second contribution degree of each knowledge fragment in the first knowledge item respective to the second vector corresponding to the first knowledge item;
determining a target knowledge fragment from the first knowledge item based on the second contribution degree;
generating second prompt information based on the first question statement, the historical dialogue information, and the target knowledge fragment;
obtaining the first reply statement output by the generative model by inputting the second prompt information into the generative model.

5. The method according to claim 1, wherein evaluating the first reply statement based on the first question statement, the first knowledge item, and the second knowledge item comprises:
determining a first similarity between the first question statement and the first knowledge item, and a second similarity between the first reply statement and the second knowledge item;
determining that the first reply statement passes the evaluation in response to a difference between the first similarity and the second similarity being less than a distance threshold.

6. The method according to claim 1, wherein evaluating the first reply statement based on the first question statement, the first knowledge item, and the second knowledge item comprises:
generating third prompt information based on the first knowledge item, the first question statement, the second knowledge item, and the first reply statement;
inputting the third prompt information into an evaluation model and obtaining an evaluation result output by the evaluation model.

7. The method according to claim 6, wherein generating the third prompt information based on the first knowledge item, the first question statement, the second knowledge item, and the first reply statement comprises:
receiving a third knowledge item associated with the first reply statement from the knowledge base;
obtaining a fused knowledge item and a weight of the fused knowledge item by fusing the third knowledge item and the second knowledge item;
generating the third prompt information based on the first knowledge item, the first question statement, the first reply statement, the fused knowledge item, and the weight of the fused knowledge item.

8. The method according to claim 7, wherein a process of determining the weight of the fused knowledge item comprises:
determining a third similarity between the fused knowledge item and the first reply statement, and the number of occurrences of the fused knowledge item in the second knowledge item and the third knowledge item;
determining the weight of the fused knowledge item based on the third similarity and/or the number of occurrences.

9. The method according to claim 1, wherein, after evaluating the first reply statement, the method further comprises:
in response to the first reply statement failing the evaluation, obtaining a second reply statement output by the generative model by inputting an evaluation result corresponding to the first reply statement into the generative model;
returning to perform an evaluation operation based on the second reply statement, until an reply statement that passes the evaluation is obtained and output.

10. The method according to claim 1, wherein, after outputting the first reply statement, the method further comprises:
in response to receiving the second question statement for the first reply statement, generating and outputting a third reply statement corresponding to a second question statement;
in response to receiving no third question statement for the third reply statement, generating a target reply statement corresponding to the first question statement based on the first reply statement and the third reply statement;
storing the first question statement and the target reply statement in a predefined database, wherein data in the predefined database is used to perform update training on the generative model.

11. An electronic device, comprising:
at least one processor; and
a memory communicatively coupled to the at least one processor;
wherein the at least one processor is configured to:
acquire a current first question statement and historical dialogue information associated with the first question statement;
acquire, from a knowledge base, a first knowledge item associated with the first question statement and a second knowledge item having a question-answer relationship with the first knowledge item;
obtain a first reply statement output by a generative model by inputting the first question statement, the first knowledge item, and the historical dialogue information into the generative model;
evaluate the first reply statement based on the first question statement, the first knowledge item, and the second knowledge item; and
output the first reply statement in response to the first reply statement passing evaluation.

12. The electronic device according to claim 11, wherein the at least one processor is configured to:
determine a first similarity between a first vector corresponding to the first question statement and a second vector corresponding to each of knowledge items in the knowledge base;
determine a knowledge item with a corresponding first similarity greater than a similarity threshold as the first knowledge item; and
determine the second knowledge item having the question-answer relationship with the first knowledge item based on a third vector corresponding to the first knowledge item, wherein the third vector represents an association relationship between the first knowledge item and other knowledge items.

13. The electronic device according to claim 12, wherein the at least one processor is configured to:
in response to a plurality of first knowledge items being present, determine a first contribution degree of each of the plurality of first knowledge items based on a similarity corresponding to each first knowledge item;
generate a first prompt information based on the first question statement, the historical dialogue information, the plurality of first knowledge items, and the first contribution degree of each first knowledge item; and
obtain the first reply statement output by the generative model by inputting the first prompt information into the generative model.

14. The electronic device according to claim 12, wherein the at least one processor is configured to:
in response to the first knowledge item being a predefined type item, determine a second contribution degree of each knowledge fragment in the first knowledge item respective to the second vector corresponding to the first knowledge item;
determine a target knowledge fragment from the first knowledge item based on the second contribution degree;
generate second prompt information based on the first question statement, the historical dialogue information, and the target knowledge fragment;
obtain the first reply statement output by the generative model by inputting the second prompt information into the generative model.

15. The electronic device according to claim 11, wherein the at least one processor is configured to:
determine a first similarity between the first question statement and the first knowledge item, and a second similarity between the first reply statement and the second knowledge item;
determine that the first reply statement passes the evaluation in response to a difference between the first similarity and the second similarity being less than a distance threshold.

16. The electronic device according to claim 11, wherein the at least one processor is configured to:
generate third prompt information based on the first knowledge item, the first question statement, the second knowledge item, and the first reply statement;
input the third prompt information into an evaluation model and obtain an evaluation result output by the evaluation model.

17. The electronic device according to claim 16, wherein the at least one processor is configured to:
receive a third knowledge item associated with the first reply statement from the knowledge base;
obtain a fused knowledge item and a weight of the fused knowledge item by fusing the third knowledge item and the second knowledge item;
generate the third prompt information based on the first knowledge item, the first question statement, the first reply statement, the fused knowledge item, and the weight of the fused knowledge item.

18. The electronic device according to claim 17, wherein the at least one processor is configured to:
determine a third similarity between the fused knowledge item and the first reply statement, and the number of occurrences of the fused knowledge item in the second knowledge item and the third knowledge item;
determine the weight of the fused knowledge item based on the third similarity and/or the number of occurrences.

19. The electronic device according to claim 11, wherein the at least one processor is configured to:
in response to the first reply statement failing the evaluation, obtain a second reply statement output by the generative model by inputting an evaluation result corresponding to the first reply statement into the generative model;
return to perform an evaluation operation based on the second reply statement, until an reply statement that passes the evaluation is obtained and output.

20. A non-transitory computer readable storage medium, having computer instructions stored thereon, which causes a computer to perform a method for generating a dialogue, wherein the method comprises:
acquiring a current first question statement and historical dialogue information associated with the first question statement;
acquiring, from a knowledge base, a first knowledge item associated with the first question statement and a second knowledge item having a question-answer relationship with the first knowledge item;
obtaining a first reply statement output by a generative model by inputting the first question statement, the first knowledge item, and the historical dialogue information into the generative model;
evaluating the first reply statement based on the first question statement, the first knowledge item, and the second knowledge item; and
outputting the first reply statement in response to the first reply statement passing evaluation.
